(19) United States
(12) Patent Application Publication
(10) Pub. No.: US 2009/0007597 A1
(43) Pub. Date: Jan. 8, 2009

(54) Body attached band with removal visual image pockets

(76) Inventor: Gail F. Hanevold, Bloomington, MN (US)

Correspondence Address: Donald W. Meeker;Patent Agent, 924 East Ocean Front # E, Newport Beach, CA, 92661, US

(21) Appl. No.: 11/824,748

(22) Filed: Jul. 2, 2007

(51) Int. Cl. A44C 13/00; G09B 19/00

(52) U.S. Cl. 63/1.14; 434/238

(57) ABSTRACT

A band worn on the body as a wrist band, arm band, ankle band, leg band, neck band, or waist band, with removable vinyl picture pockets that functions as a behavioral incentive, a portable visual communication system, and/or is used to display collectable stamps, pictures, mini trading (sport) cards, etc. Ends of the band are adjustably interconnected and pockets are removably attached by mating hook and loop fasteners, snaps, or mating magnetically attractive materials.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to behavior control or modification and particularly to a body attached band comprising a strap having a plurality of detachable mini-pouches or pockets for removable attachment to the band; the mini-pouches or pockets being made of clear vinyl that hold visual image bearing sheets, such as pictures, photographs, stickers, logos, etc. that may be used as a behavioral incentive and for a communication tool for a child and for collecting images.

2. Description of Related Art Including Information Disclosed Under 37 CFR 1.97 and 1.98

Most prior art behavior modifications systems involve behavioral aids external to the child, lack a direct personal contact with the child, and are not constantly visible to a child as a continual reminder for the child. With the exception of trading cards, these pieces are usually laminated, which takes extra time and money from the adults who implement these strategies. Today, behavior charts, picture schedules, and sports collections, are either posted in the classroom, or carried around in a 3 ring binder, or are in a trophy case at home, respectively. When used as part of a speech or behavior program, the lack of mobility prohibits or severely impedes these programs from being carried out in the community, or in transit, in school cafeteria's, the playground, the hallway, or in different settings where the information is not posted, or easily accessed. None of the prior patents provide a traveling wristband which provides consistency of programming, and/or easy access to communicate through out all environments.

Behavior of children has often been tracked and rewarded using charts or display boards, such as that found in U.S. Pat. No. 5,954,512 issued to Fruge on Sep. 21, 1999. The Fruge Patent provides a board for recording behavioral attributes of one or more persons in a group over a period of time, e.g., a child in a household over a period of one week. The board is preferably visible to the person whose behavior is being monitored, and serves as a reminder of some reward for good behavior on the part of the person, or withholding of such reward and/or possible punishment for poor behavior.

U.S. Patent Application #20010046661, published Nov. 29, 2001 to Shorter, shows a teaching apparatus designed to enhance the lives of teachers and adults in their attempts to teach handicapped individuals by assisting them in locating visual pictures during activities at home or at school. The invention is attached to a belt, which would be strapped around a user's waist. The present invention would also have a pair of removable felt pads, which a user would be able to attach pictures to, with the flaps being removable at the will of a user. When an adult or teacher would wish to communicate with someone, the adult or teacher would simply remove the picture and hand it to the user. The present invention would also have a front-mounted pad with an enclosed pouch which would be used for storing extra pictures and drawings, with pad including the enclosed pouch being located in front of the other two pair of flaps.

U.S. Patent Application #20030221449, published Dec. 4, 2003 by DeShong, concerns an article of jewelry, namely a cuff-style molded bracelet of transparent plastic material, comprised of two parts, a band body and a removable transparent lens whereby one could display and change photographs, pictures, i-Zone™, mini-photos, or other decorative items. The invention constitutes an easily customized, attractive piece of jewelry for displaying your favorite picture on the wrist. “i-Zone™” and the other names of products of Polaroid Corporation, are trademarks of Polaroid Corporation.

U.S. Patent Application #20050037323, published Feb. 17, 2005 by Basson, claims a method of encouraging a person to modify a behavior. The method includes providing a charm holder capable of being worn by the person and adjusting the number of charms attached to the charm holder as a function of the behavior of the person. The charm holder may be a necklace or bracelet that includes a plurality of chains that are combined together via magnetic clasps. Each of the chains may have a length of no greater than seven inches.

U.S. Pat. No. D497,826, issued Nov. 2, 2004 to Nelson, concerns the ornamental design for a bracelet for holding graphical displays.

U.S. Pat. No. D463,308, issued Sep. 24, 2002 to Skiles, describes the ornamental design for picture frame jewelry.

U.S. Pat. No. D55,788, issued Jul. 13, 1920 to Griffin, illustrates the ornamental design for a novelty picture bracelet.

U.S. Pat. No. D334,150, issued Mar. 23, 1993 to Cuddeback, claims the ornamental design for a display bracelet.

U.S. Pat. No. 5,081,852, issued Jan. 21, 1992 to Cox, discloses a bracelet having a band containing plurality of individualized transparent compartments with removable transparent windows for displaying on the wrist numerous pictures, photographs, or other decorative or useful items. Only the windows of the compartments not the frame portions are easily interchangeable and may be transparent, flat, convex for magnification, or some other suitable design. The invention constitutes a multipurpose and easily customized bracelet. Also the inner wall of the band is transparent to permit display of photographs or pictures back-to-back on both sides of the bracelet.

What is needed is a child behavior modification and communication and collecting system which has detachable pockets with visible images that convey different meanings, which are worn on the body in direct personal contact with the child.

### BRIEF SUMMARY OF THE INVENTION

An object of the present invention is to provide a bracelet, armband, necklace, or other body attachable device with replaceable clear plastic pockets for carrying images placed in the pockets as a child behavior modification and communication system and collection device which is in direct personal contact with the child, and is constantly visible to a child as a continual reminder for the child which may be held on by hook and loop fasteners, snaps, magnets, or other removable attaching means.

Another object of the present invention is to provide a child behavior and communication system and collection display device which provides easily replaceable images by replacing pockets on the hook and loop fastener bracelet or replacing images in the pockets.

One more object of the present invention is to provide vinyl pouches which are re-usable, refillable, and removable, and serve many functions when attached to the band.

In brief, the present invention comprises a band worn on the body as a wrist band, arm band, ankle band, leg band, neck band, or waist band, with removable vinyl picture pockets that functions as a behavioral incentive, a portable visual communication system, and/or is used to display collectable stamps, pictures, mini trading (sport) cards, etc.

Teachers/parents/psychologists/marketers insert student/child/customer preferred pictures/stickers/logos, etc into the pouches. They can be earned/applied one at a time when used as incentives/reinforcements for positive behavior. They can also be removed or traded with one another if this is used as a collection or cost response behavioral strategy. Special educators, speech clinicians, and parents of children with autism or cognitive impairments may use this as a portable or mobile picture schedule, or communication system to assist the individual in following the sequence itemized on the wrist band, or allowing him/her to remove and show an adult what they want from the choices on the band. Often times, when used as a behavioral incentive, the supervising adult will wear one of these bands with the child's preferred items attached, and will transfer one item at a time to the child's wristband when indicated/earned. Athletic teams, etc. may use this as a marketing tool, and give out one player picture per game to attract a juvenile audience and encourage the building of a collection that fans can “sport” on their wrists and share with peers.

An advantage of the present invention is that it may be used as a transportable behavior incentive with elementary aged mainstream (regular education) children as well as many other groups.

Another advantage of the present invention is that it provides individualized detachable picture holders capable of conveying different meanings to different audiences.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the band of the present invention showing the pockets with indicia bearing sheets aligned for attachment to the band;

FIG. 2 is a perspective view of the band of FIG. 1 showing the pockets with indicia bearing sheets attached around the band;

FIG. 3 is a top plan view of the band of FIG. 1 showing the pockets with indicia bearing sheets attached around the band and the ends of the band attached together;

FIG. 4 is a perspective view of the band of the present invention with a first end of the band inserted through a loop at the second end and the first end overlapping itself and attaching with a hook and loop fastener connector and showing the pockets with indicia bearing sheets aligned for attachment to the band by hook and loop fastener connections;

FIG. 5 is a top plan view of the band of FIG. 4 showing the pockets with indicia bearing sheets attached around the band and the ends of the band attached together;

FIG. 6 is a perspective view of the band of the present invention with a band of either magnetic material on an exterior or a magnetically attractive material, such as a magnetically attractive metal, and the pockets are attachable to the band by a mating strip of material to create a magnetic attraction between the pockets and the band to hold the pockets on the band and a first end of the band has an interior mating strip of material to overlap the second end and adjustably attach thereto by magnetic attraction, and showing the pockets with indicia bearing sheets aligned for attachment to the band by magnetic attraction;

FIG. 7 is a perspective view of the band of the present invention with a band having spaced paired snap receiver elements around the exterior of the band pockets are attachable to the band by a mating pair of snap inserter elements on the back of each pocket to snap the pockets onto the band and a first end of the band has an interior mating pair of snap inserter elements to overlap the second end and adjustably attach thereto by snapping onto one of the pairs of snap receiver elements, and showing the pockets with indicia bearing sheets aligned for attachment to the band by snaps;

FIG. 8 is a perspective view of the band of FIG. 1 showing the pockets with indicia bearing sheets attached around the band and the band attached around the wrist of a wearer;

FIG. 9 is a perspective view of the band of FIG. 1 showing the pockets with indicia bearing sheets attached around the band and the band attached around the ankle of a wearer.

### DETAILED DESCRIPTION OF THE INVENTION

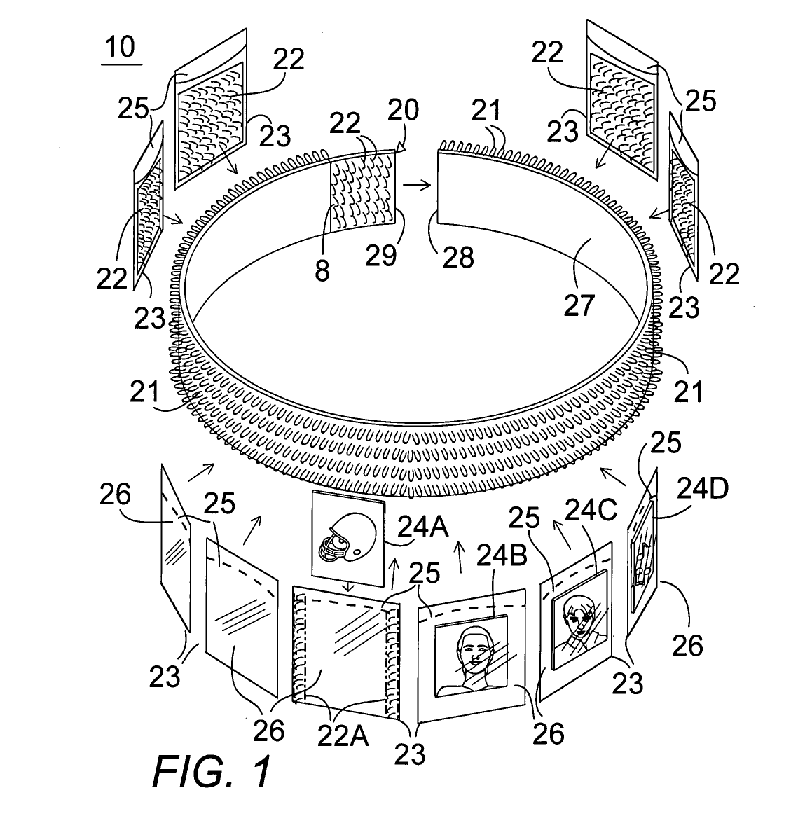

In FIGS. 1-9, a body worn band device 10 for behavior modification and communication and collecting comprises a band 20 with a series of removably attached pockets 23 with clear front windows 26 each revealing an indicia bearing sheet 24A therein related to the behavior of the wearer.

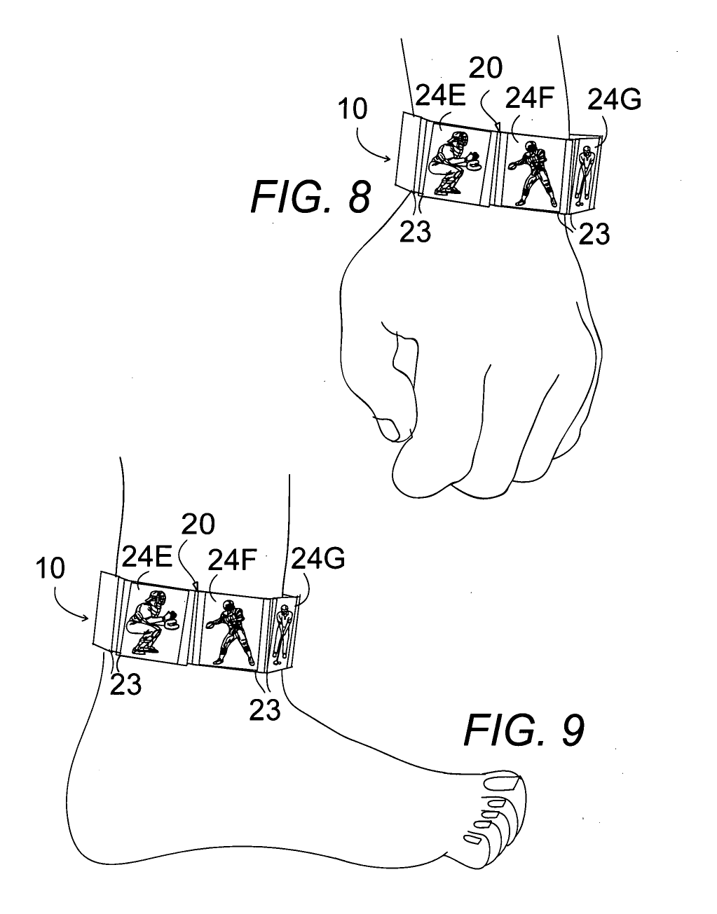

The band 20 comprises an elongated strip of flexible material for encircling a wrist, arm, ankle, leg, neck waist, or other portions of a wearer of the band. In FIGS. 1-5, the band 20 preferably comprises an exterior surface of one of the mating materials of a mating hook and loop fastener, preferably loop material 21, along the length of the band. A first end of the band preferably bears the other of the mating materials of a mating hook and loop fastener on the interior of the first end, preferably hook material 22, attached thereto, which may be a strip 8 welded to the end, so that the first end of the band overlaps the second end of the band with mating loop material 21 on the exterior, as shown in FIG. 3, to adjustably fit the wrist or other body part of the wearer, as shown around a wrist in FIG. 8 and around an ankle in FIG. 9, for removably securing the band around the wrist or other body part of the wearer by securing the mating hook and loop fastener materials.

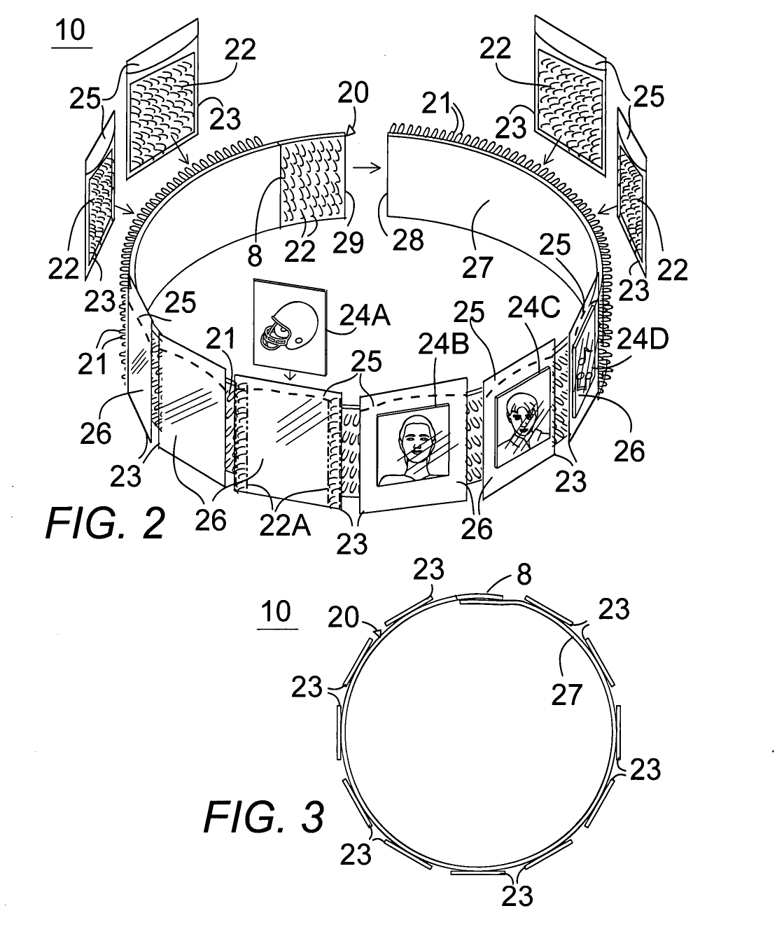

A series of pockets 23 are removably attached around the band 20, each of the pockets comprising an envelope having an interior space and at least one opening 25 for receiving and retaining a visual image bearing insert 24A-24G therein. A front transparent surface 26 allows viewing the visual image bearing insert 24A-24G inside. In FIGS. 1-5, the other of the mating materials, preferably a hook material 22, of a mating hook and loop fastener, is adhered to at least a portion of a back surface of the pocket for removably attaching the pocket on the band in a desired position secured by the mating hook and loop fastener, as shown in FIGS. 2, 3, 8 and 9. Each of the pockets 23 preferably comprises an envelope fabricated of transparent plastic material having an edge opening 25 therein to insert the indicia bearing sheets 24A-24G, the edge opening comprising a back top of the pocket or envelope cut lower than the front for ease of insertion and removal of the visual image sheet 24.

A series of indicia bearing inserts 24A-24G are removably insertable in the series of pockets 23. Each of the series of visual image bearing inserts 24A-24G comprises a sheet of material sized to fit in one of the series of pockets 23, the sheet of material having a visual image on at least one side thereof, the visual image being associated with a related behavior of the, wearer of the band so that the visual image is always visible to the wearer as a reminder of the behavior or being used in communication or for collecting.

In FIG. 1 an optional section of the other of the mating materials, preferably hook material 22A, of a mating hook and loop fastener may be adhered to a portion of the front side of each pocket so that when a certain behavior is completed, the pocket containing the indicia bearing insert related to the certain behavior can be turned over and attached face down on the wristband. The student will then know it has been completed and will focus on the next picture/task.

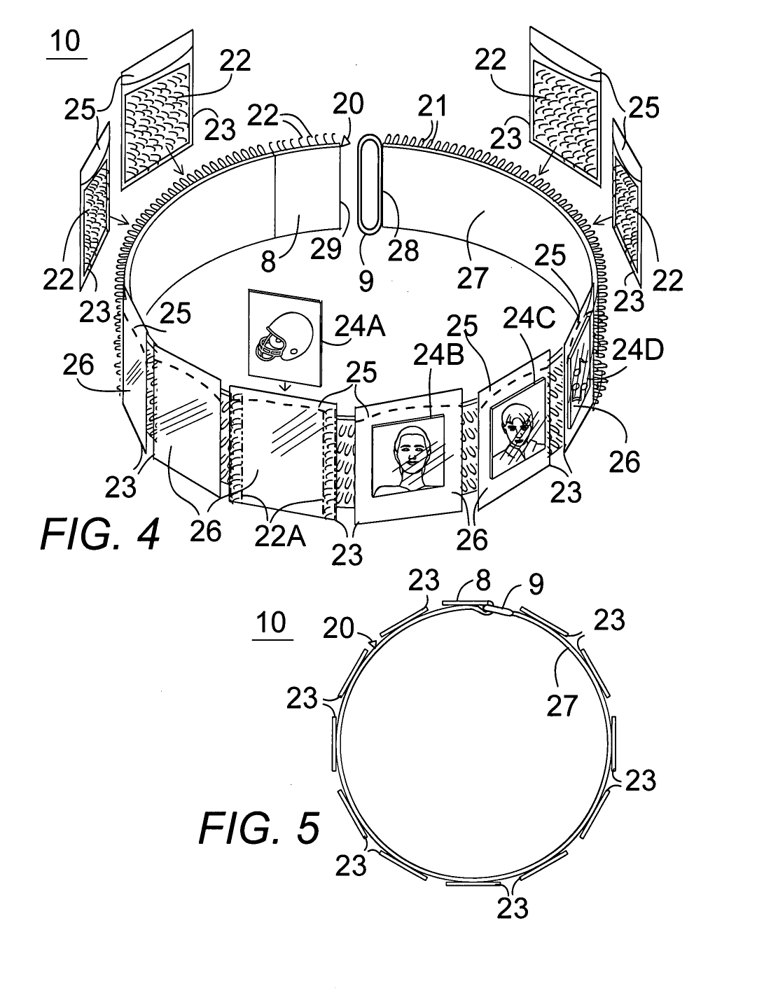

In FIGS. 4 and 5, the band 20 comprises an exterior surface of one of the mating materials of a mating hook and loop fastener, preferably loop material 21, along the length of the band and a first end 29 of the band bears the other of the mating materials of a mating hook and loop fastener, preferably hook material 22 which may be a strip 8 welded to the end, attached on the exterior surface and a second end 28 of the band has a rigid loop 9 attached thereto so that the first end of the band 29 with the strip 8 of hook material 22 is inserted through the loop 9 at the second end 28 and the first end with the strip 8 overlaps itself and attaches to itself with a mating hook and loop fastener connection.

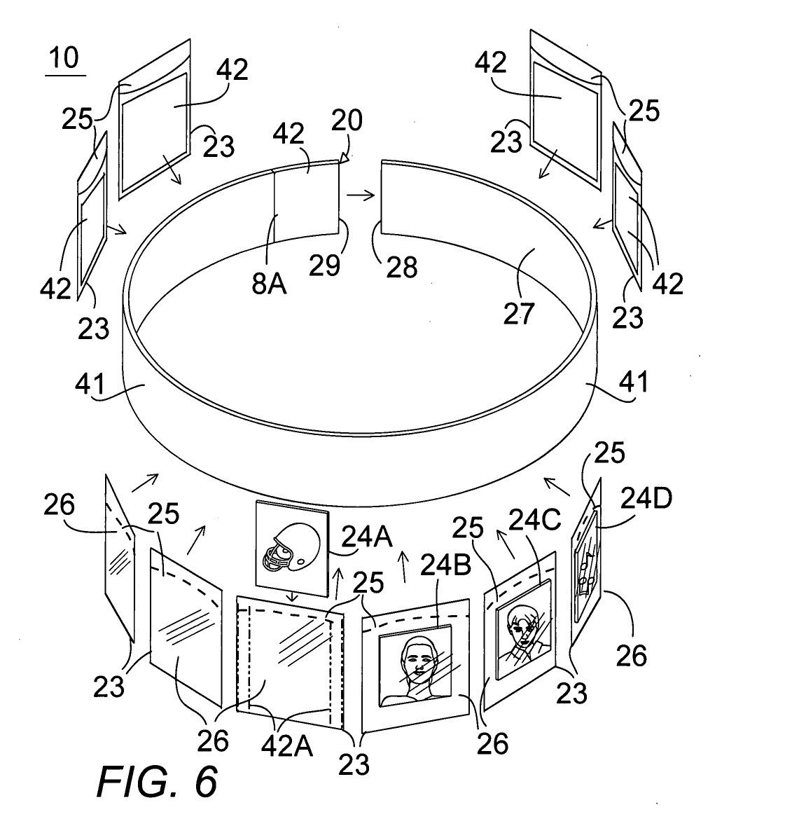

In FIG. 6, the band 20 comprises an exterior surface of either magnetic material or a magnetically attractive material 41, such as a magnetically attractive metal, and the pockets are attachable to the band by a mating strip of material 42 to create a magnetic attraction between the pockets 23 and the band 20 to hold the pockets on the band and a first end 29 of the band has an interior mating strip of material 8 to overlap the second end 29 and adjustably attach thereto by magnetic attraction.

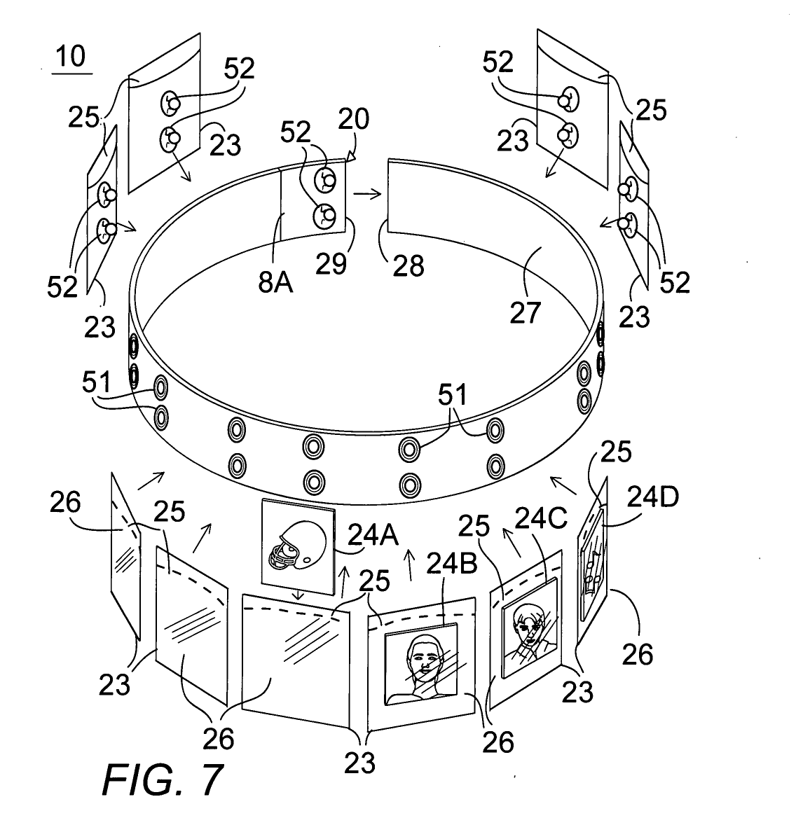

In FIG. 7, the band 20 comprises an exterior having a series of spaced paired snap receiver elements 51 around the exterior of the band and the pockets 23 are attachable to the band 20 by a mating pair of snap inserter elements 52 on the back of each pocket 23 to snap the pockets 23 onto the band 20 and a first end 29 of the band has at least one interior mating pair of snap inserter elements 52 to overlap the second end 28 of the band and adjustably attach thereto by snapping onto at least one of the pair of snap receiver elements 51.

The present invention preferably comprises an 8×¾ inch Velcro® band 20 which is made of Velcro® loop 21 on the entire length of the top side for a wrist band or longer for other applications, such as an armband, ankle band, leg band, neck band, or waistband. On this side there will be five or six or more detachable mini picture/sticker holders/pouches/pockets 23 preferably made out of 8 gauge clear vinyl. Preferably, the pockets are ⅞ inches wide and 1¼ inches tall, and have an ⅛ inch lip at the opening on the ⅞ inch side. They extend a bit over both edges of the ¾ inch band. Each pouch has a ¾ in. Velcro® pressure sensitive hook material 22 attached to the short lipped side. This band is backed on the inside 27 of the band with the fabricated backing on hook and loop fastener strips or an interior surface of the band of a material taken from the list of materials including Tyvek®, nylon, polyester, leather, vinyl, silicone and one end has a Velcro® hook fastener material 22. This end will over-lap onto the loop side, making it fasten and adjust to any size wrist or other part of the body to which it attaches.

In use, teachers/parents/psychologists/marketers insert student/child/customer preferred pictures/stickers/logos, etc into the pockets 23. They can be earned/applied one at a time when used as incentives/reinforcements for positive behavior. They can also be removed or traded with one another if this is used as a collection or cost response behavioral strategy. Special educators, speech clinicians, and parents of children with autism or cognitive impairments may use this as a portable or mobile picture schedule, or communication system to assist the individual in following the sequence itemized on the band 20, or allowing him/her to remove and show an adult what they want from the choices on the band. Often times, when used as a behavioral incentive, the supervising adult will wear one of these band devices 10 with the child's preferred items attached, and will transfer one item at a time to the child's band when indicated/earned. Athletic teams, etc. may use this as a marketing tool, and give out one player picture per game to attract a juvenile audience and encourage the building of a collection that fans can “sport” on their bands and share with peers.

The band device 10 with removable vinyl picture pockets 23 may function as a behavioral incentive, a portable visual communication system, and/or used to display collectable stamps, pictures, mini trading (sport) cards, etc.

It is understood that the preceding description is given merely by way of illustration and not in limitation of the invention and that various modifications may be made thereto without departing from the spirit of the invention as claimed.

What is claimed is:

1. A band device worn on a body of a user for behavior modification, communication, and collecting, the device comprising:
a band comprising an elongated strip of flexible material for encircling a portion of a body of a wearer, the band comprising means for adjustably attaching the band to the portion of the body of the wearer and means for removably attaching items along the length of the band;
a series of pockets removably attached along the length of the band, each of the pockets comprising an envelope having an interior space and at least one opening for receiving and retaining a visual image bearing insert therein, a front transparent surface for viewing the visual image bearing insert, and means for mating with the means for removably attaching items along the length of the band on at least a portion of a back surface of the pocket for removably attaching the pocket to the band in a desired position along the length of the band;
a series of visual image bearing inserts removably insertable in the series of pockets, each of the series of visual image bearing inserts comprising a sheet of material sized to fit in one of the series of pockets, the sheet of material bearing a visual image on at least one side thereof so that the indicia is always visible to the wearer through the front transparent surface of the envelope, so that the inserts are removably insertable in the pockets and the pockets are removably attachable to the band for the purposes of behavior modification using the visual images, communication using the visual images, and collecting and displaying the visual images.

2. The device of claim 1 wherein the band comprises an exterior surface of one of the mating materials of a mating hook and loop fastener along the length of the band and a first end of the band bearing the other of the mating materials of a mating hook and loop fastener attached on a bottom side of the first end so that the first end overlaps the second end of the band for an adjustable closure.

3. The device of claim 2 further comprising a section of the other of the mating materials of a mating hook and loop fastener on a portion of the front side of each pocket so that when a certain behavior is completed, the pocket containing the indicia bearing insert related to the certain behavior can be turned over and attached face down on the wristband. The student will then know it has been completed and will focus on the next picture/task.

4. The device of claim 1 wherein the band comprises an exterior surface of one of the mating materials of a mating hook and loop fastener along the length of the band and a first end of the band bearing the other of the mating materials of a mating hook and loop fastener attached on the exterior surface and a second end of the band having a rigid loop attached thereto so that the first end of the band is inserted through the loop at the second end and the first end overlaps itself and attaches to itself with a mating hook and loop fastener connection.

5. The device of claim 1 wherein the band comprises an exterior surface of either magnetic material or a magnetically attractive material, such as a magnetically attractive metal, and the pockets are attachable to the band by a mating strip of material to create a magnetic attraction between the pockets and the band to hold the pockets on the band and a first end of the band has an interior mating strip of material to overlap the second end and adjustably attach thereto by magnetic attraction.

6. The device of claim 1 wherein the band comprises an exterior having a series of spaced snap receiver elements around the exterior of the band and the pockets are attachable to the band by a mating snap inserter element on the back of each pocket to snap the pockets onto the band and a first end of the band has at least one interior mating snap inserter element to overlap the second end of the band and adjustably attach thereto by snapping onto at least one of the snap receiver elements, and showing the pockets with indicia bearing sheets aligned for attachment to the band by snaps;

7. The device of claim 1 wherein the visual images are always visible to the wearer as a reminder of the behavior the indicia associated with a related behavior of the wearer of the band.

8. The device of claim 1 wherein each of the pockets comprises an envelope fabricated of transparent plastic material having an edge opening therein.

9. The device of claim 1 wherein an interior surface of the band is faced with a material taken from the list of materials including Tyvek®, nylon, polyester, leather, vinyl, silicone.
